(19) United States
(12) Patent Application Publication
(10) Pub. No.: US 2026/0340987 A1
(43) Pub. Date: Oct. 29, 2026

(54) AUTOMATED FOOTWEAR IDENTIFICATION SYSTEM AND METHOD

(71) Applicant: Bluestar Software Limited, Reading, Berkshire (GB)

(72) Inventors: Akanda Wahid Ul ASHRAF, Cumilla (BD); Marcin BUDKA, Reading, Berkshire (GB); Richard Scott NEVILLE, Reading, Berkshire (GB)

(73) Assignee: Bluestar Software Limited, Reading, Berkshire (GB)

(21) Appl. No.: 19/107,126

(22) PCT Filed: Aug. 17, 2023
(86) PCT No.: PCT/GB2023/052163

§ 371 Date: Feb. 27, 2025

(30) Foreign Application Priority Data
Aug. 31, 2022 (GB) 2212596.7

(51) Int. Cl. G06V 10/764; G06F 16/51; G06F 16/532; G06V 10/82

(52) U.S. Cl. CPC G06V 10/764; G06F 16/51; G06F 16/532; G06V 10/82

(57) ABSTRACT

A system for identifying footwear outsoles, the system comprising an image obtaining unit operable to obtain a query image, the image comprising at least a portion of a footwear outsole, an inputting unit operable to input the query image to a trained machine learning model, the model being trained upon a data set comprising a footwear database and one or more augmented versions of entries in the footwear database, a candidate obtaining unit operable to obtain one or more candidate identifications of the footwear using the trained machine learning model, the candidates being entries in the footwear database, and a candidate selection unit operable to select one of the candidate identifications as the identity of the footwear outsole of the query image.

### BACKGROUND OF THE INVENTION

### Field of the invention

This disclosure relates to an automated footwear identification system and method.

### Description of the Prior Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Criminal investigations aim to establish the circumstances in which a crime was committed. This can help to catch the instigators of a crime by providing intel in a timely and reliable manner, and/or to prove that those accused of a crime are the guilty party.

The material collected as part of an investigation can be varied, including material such as fingerprints, footwear, and digital material on computer hard drives. These can be used in all stages of the investigation including the production of intelligence to guide an investigation through to court submissions of evidence to secure a verdict. The present disclosure focuses on physical evidence such as footwear impressions, left in soft materials or on surfaces, which are either recovered from a crime scene or collected in custody.

In policing footwear impressions are normally collected in two scenarios. The first of these is in custody with physical access to the detainee's footwear, while the second is at a crime scene from marks left on various surfaces. The vast majority of the footwear impressions captured from detainees in custody follow one of the below processes:

Impressions using paper: these inked impressions are captured using a specialist pad and paper kit (sometimes known as a ‘bigfoot’ kit). The kit uses a pad with a reactive chemical and specialist paper. The impressions can then be digitised using an office document scanner if required.

Impressions captured digitally: a specialised footwear impression digital scanner is used in this case to capture the footwear impression without any use of ink. This process produces only a digital copy of the impression whereas the inked impression using paper also produces a physical copy on paper.

Outsole photographs: this simply involves taking a photograph of the outsole. This tends to be used less frequently than the capturing of impressions using paper-based or digital methods, with only a minority of police forces using photography in this manner.

The above can be referred to as outsole impressions, and these can be used to identify the model of footwear worn by someone held in custody to aid in the investigation. For instance, this information can be used to provide initial evidence to link a person to a crime scene where impressions or prints corresponding to the same footwear model have been identified (although such evidence is unlikely to be conclusive, given the number of different instances of a particular footwear model in circulation).

Further applications of footwear forensics may include analysis of crime scenes to establish a range of information including the number of people at a crime scene, the footwear worn by each of those people, and the activity of those people while at the scene. Additional evidence that may be considered during a footwear forensics analysis include insole imprints left by a wearer, and/or the analysis of items embedded in footwear.

Currently, the analysis of outsole impressions to identify specific footwear is typically performed manually by experts; the availability of such experts can therefore act as a bottleneck in the forensics process. It is therefore considered advantageous if the identification process can be made more efficient as this can enable a timelier processing of evidence.

One approach that has been previously proposed is that of increasing the efficiency of the data collection process; this can be through the enhancement of impression recording, for instance. Such techniques enable the materials to be gathered and processed more quickly, which can ease the delay in acquiring results of the forensic analysis.

It is in the context of the above discussion that the present disclosure arises.

### SUMMARY OF THE INVENTION

This disclosure is defined by claim 1.

Further respective aspects and features of the disclosure are defined in the appended claims.

It is to be understood that both the foregoing general description of the invention and the following detailed description are exemplary, but are not restrictive, of the invention.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates an exemplary set of footwear descriptors;

FIG. 2 schematically illustrates a method for identifying one or more candidate footwear outsoles;

FIG. 3 schematically illustrates the generation of an exemplary dataset;

FIG. 4 schematically illustrates exemplary modifications;

FIG. 5 schematically illustrates a training method for a machine learning model;

FIG. 6 schematically illustrates a method for utilising a trained model;

FIG. 7 schematically illustrates a system for performing a footwear model identification process;

FIG. 8 schematically illustrates a method for identifying footwear outsoles;

FIG. 9 schematically illustrates a system for training a machine learning model for the identification of footwear outsoles; and

FIG. 10 schematically illustrates a method for training a machine learning model and generating a search tree for the identification of footwear outsoles.

### DESCRIPTION OF THE EMBODIMENTS

Referring now to the drawings, wherein like reference numerals designate identical or corresponding parts throughout the several views, embodiments of the present disclosure are described.

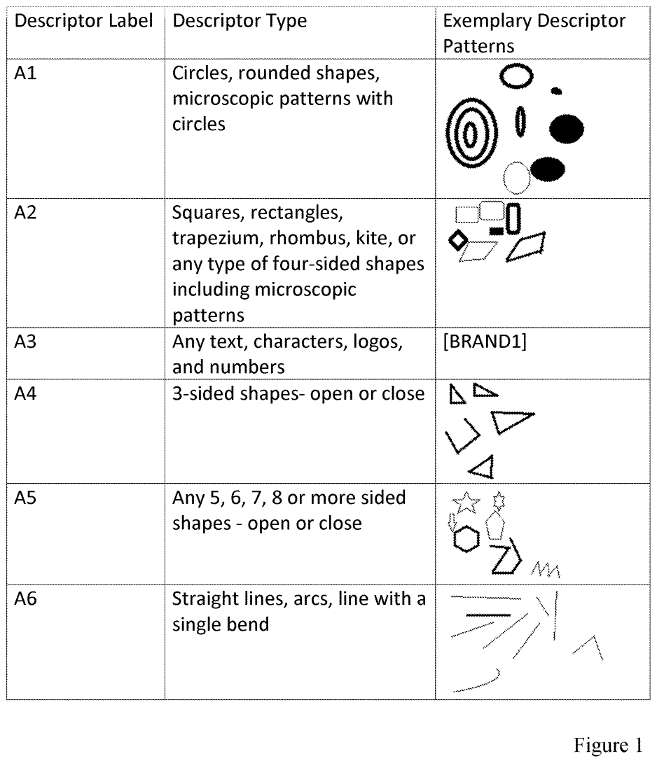

Outsole impression matching processes that are currently used (that is, the identification of a type or model of shoe that corresponds to an obtained print or the like) are manual and generally utilise a set of descriptors; an exemplary set of these are shown in FIG. 1. These descriptors are an exemplary set which are presented here to aid the discussion of the present disclosure. In practice, other sets of descriptors may be used—for instance, those used for the UK's National Footwear Reference Collection (NFRC) may be considered appropriate, although different organisations may use different reference collections and descriptors. It should be noted the techniques disclosed in the present document are not limited to any particular set of descriptors or reference collections, but instead can be adapted freely for different implementations as is discussed below.

The six descriptors shown in FIG. 1 are examples of labels that can be used to indicate which features are present in the outsole pattern of a shoe. These descriptors can be associated with an indication of a location and the type of the feature to provide a more precise indication of properties of footwear (for instance, to indicate whether the feature is found in the heel area or the front area of the shoe). A particular shoe may be described using a single descriptor in some cases, while in others several may be required if there is a more complex arrangement of features. For instance, a shoe that has an outsole which includes a number of three-, four-, and five-sided shapes would correspond to each of the indicators A3, A2, and A5 accordingly.

It should also be noted that there may be overlaps between descriptors, rather than each necessarily being an independent feature. For instance, descriptors A3 and A4 may overlap when a logo is present that comprises one or more triangles, and both may be indicated for a particular footwear model (such as a particular brand and/or style, rather than a specific instance of footwear).

The exemplary descriptors shown in FIG. 1 represent a small set of possible descriptors; in practice it may be considered that descriptors for other patterns or features may be defined (such as a general ‘texture’ feature) or that subdivisions of descriptors may be used (such as a category A6-1 which could indicate repeated straight lines or arcs to form a pattern). Any alternative set of descriptors able to represent a diverse range of footwear outsole features may be considered appropriate, rather than being limited to the examples shown.

It is therefore apparent that the use of simple descriptors can still give rise to a complex set of information representing a particular footwear model.

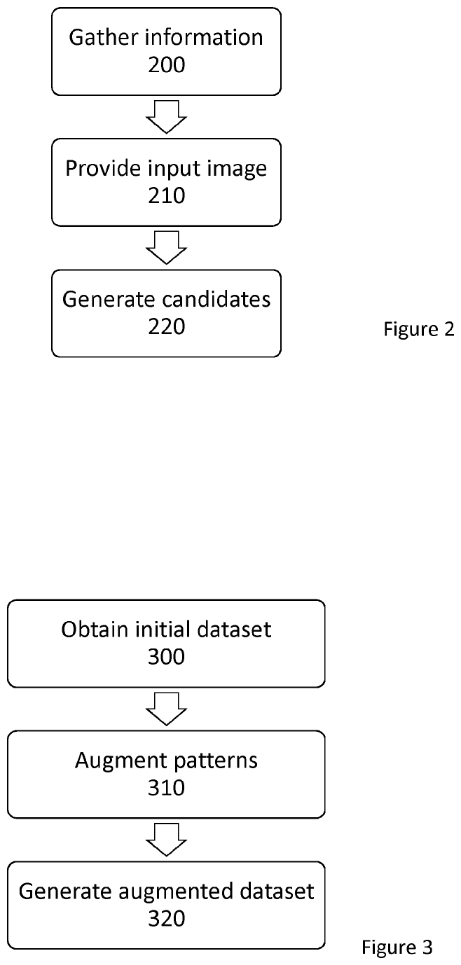

FIG. 2 schematically illustrates a method for identifying one or more candidate footwear outsoles from a database in dependence upon an input image. Further details about these steps are provided separately to this method so as to aid the clarity of the discussion.

A step 200 comprises gathering information about footwear to be identified, in particular relating to the appearance of the footwear outsole. This information is in the form of an image which is generated through any method of recording a print found at a scene or capturing information from footwear directly; examples of these are discussed above. In the case of capturing information from footwear itself, this may be performed using any of a number of suitable methods including image-based scanning techniques (in which images are captured and used to generate a two-or three-dimensional representation of the outsole) or applying ink to the outsole and obtaining a print for example.

In the case of recording a print or impression left at a crime scene, numerous methods exist which may be selected from in dependence upon environmental conditions, for instance, and the type of mark that is left by the footwear. Dry marks may be caused by the deposit of a dry substance, such as dust, when footwear comes into contact with a surface—such marks may be recorded using imagery, or electrostatic/gelatine lifting for example. Similarly, wet marks are created when a wet substance (such as water) is deposited on a surface by footwear. These marks may be enhanced using a contrasting agent (such as a black powder if the mark is on a white surface), and may be lifted using gelatine lifting techniques (for example).

In some cases, it may be possible to cast a three-dimensional impression of a footwear impression—for instance, if the footwear has been used in an environment having a soft surface. This leads to an inverted representation of the print (in effect, a representation of the outsole of the footwear) which can be used to generate an image for identification.

A step 210 comprises providing an image corresponding to the footwear to be identified as an input to a trained predictive model. The predictive model, the training of which is discussed in more detail below, is configured to accept an input image that represents the outsole pattern of footwear that is being queried. In some embodiments, this step may require the generation of an image to provide as an input based upon the information gathered in step 200.

For example, the information gathered in step 200 can be used to generate an image for use in the identification—this may include modifications to a captured image (such as to remove excess image content, resize an image, or to adjust a contrast or otherwise enhance an image, for example using interpolation techniques) as well as the conversion of data into a digital image format. An example of such a conversion is to capture an image of a lifted footprint, or to use a computer program to generate an appropriate representation.

In some cases, it may be advantageous to provide the image in a particular format or with other particular criteria—modifications may therefore be performed as a part of the input process (or prior to this) to conform with these criteria. For instance, a predefined border size around the outsole print or impression may be preferred, in response to which a cropping (or adding of a border) may be performed.

A step 220 comprises generating, using the trained predictive model, a list comprising a number of candidate footwear models based upon the likelihood, as estimated by the trained predictive model, that they correspond to the footwear to be identified (that is, the footwear present in the input image). As an output, the trained predictive model specifies one or more candidate footwear models that represent likely matches for the input image provided in step 210—in other words, the predictive model is trained to determine, based on an input image, a likely identity of the footwear which was used to generate the input image. Here, identity refers to the make and model of the footwear (or some other method of characterising the footwear) rather than a specific pair of footwear (such as matching the footwear shown in an image to a specific shoe).

Of these candidates, the one with the highest confidence may be determined to be the correct identification of the footwear, or a human operator may be consulted to select a candidate as the correct identification if the confidence levels are not sufficiently high or if multiple candidates have similar confidence levels. In the latter case, candidates with an above-threshold confidence score or the top n (n being any integer value) candidates may be presented to the human operator for examination. In some cases, confirmation by a human operator may be preferred independent of confidence values; it is not required that a confidence-based condition is applied in order to require confirmation by a human operator.

In order to train the predictive model that is used in step 220, a suitable dataset must be obtained. In some cases, this may be a database of known footwear outsoles (such as the National Footwear Reference Collection)—however in a number of embodiments it is considered advantageous to provide a larger and more tailored dataset. FIG. 3 schematically illustrates the generation of an exemplary dataset that may be utilised in embodiments of the present disclosure.

A step 300 comprises obtaining an initial dataset of footwear outsole patterns; this dataset may also include a number of descriptors (such as those discussed with reference to FIG. 1, or any alternative set of descriptors considered suitable for indicating features of footwear outsoles) associated with some or all of the patterns in the dataset. As noted above, an example of such a dataset is that of the National Footwear Reference Collection; while any dataset may be considered useful, larger datasets are often more useful as they enable a greater chance of identification by the trained predictive model. In some cases, a dataset may be selected based upon geographical considerations—for instance, a database specific to footwear available to purchase in a particular country or region.

A step 310 comprises augmenting at least a portion of the patterns (images) in the dataset so as to generate a number of different variations on the respective patterns. This augmentation may include any suitable modification of the pattern so as to generate additional versions of the pattern that differ from the original in one or more ways. The number of additional versions of the pattern that may be generated can be set freely; in some cases, a handful of variations may be generated (such as five), while in other cases a greater number such as ten, twenty, fifty, or a hundred variations may be generated. In some embodiments, it may be considered advantageous to generate a greater number of variations; the number of variations may be in the thousands, millions, or even billions.

The variations are generated so as to provide one or more distortions and/or omissions in the base image. In other words, the augmentation causes the original (complete) image that is obtained from the dataset to be modified so as to be a partial image that represents only a portion of the original image and/or includes a distortion of one or more of the features of that original image. These variations may be entirely random, or may be selected to represent particular wear patterns or the like. A number of variations may be considered appropriate for augmenting an image, either alone or in combination. Such variations within the dataset may improve the training both through having input similar to those which would be expected (that is, partial print data) as well as by increasing the amount of training data (which can reduce overfitting of the predictive model).

For example, one variation may be that of omitting the top and/or bottom of the image to represent the curvature of a shoe that is often present. This may be a desirable variation to implement as this mimics a real-world feature of footprints/footwear impressions in that they can often omit these parts of the outsole pattern due to not making contact with the ground. Another exemplary variation is that of simulating wear on the outsole due to different walking styles. For instance, a variation could be generated which shows disproportionate wear on the inside or outside edge of the pattern to account for a wearer's pronation. Various other variations may also be considered to account for wear or modification of the pattern by a user, including picking up stones (this may cause a deviation in the pattern as elements are forced apart), dragging heels while walking, general scuffs, and/or stepping in chewing gum (this may cause features to appear connected when they are not). Variations may also be considered which mimic inaccuracies that may be introduced by footprint or outsole recording techniques, as a further example of non-random variations that can be implemented.

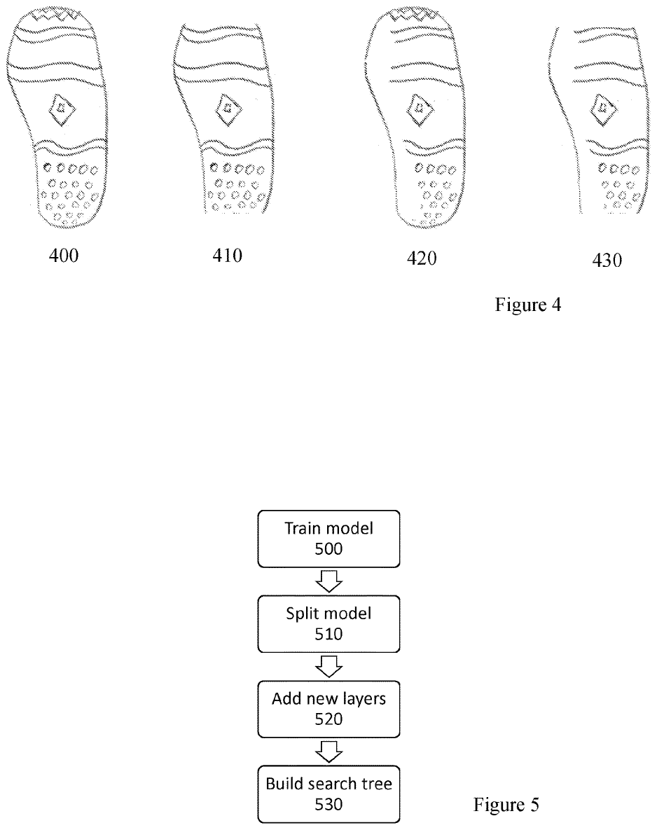

FIG. 4 schematically illustrates a simplified representation of exemplary modifications that could be implemented. The first image 400 represents a base image that could be obtained from an initial dataset; this is a complete image of an outsole. The second image 410 represents a variation in which the top and bottom portions of the outsole image have been cropped, which can correspond to the curvature of footwear meaning that the top and bottom portions of the footwear are not easily recorded. The third image 420 represents a variation in which the pattern on the inner side of the footwear isn't shown—this could be due to a partial footprint, for instance, or excessive wear on that area of the outsole. Finally, image 430 represents a variation in which multiple modifications are made (in this case, both of those shown in images 410 and 420)—this recognises the fact that multiple factors may lead to an incomplete image of the outsole being obtained.

In some cases, these variations may be applied manually by one or more human operators. However, it may be considered advantageous to automate the process by creating a script which applies one or more variations to the base images to generate variations—this may be a predetermined set of variations, or they may be selected randomly during the running of the script. Of course, any other method of automating this process may be considered.

In some embodiments the same set of variations may be used for each base image to generate a uniform set of images for each base image; that is to say that each base image may correspond to the same number of augmented images, with the augmentations applied in each of those images being the same. This may be advantageous in that the generation process for the dataset may be simplified due to the more uniform nature of the augmentation application. Alternatively, each of the base images may be augmented in different ways to generate a dataset that does not have a consistent selection of variations on each base image; indeed, the number of variations may vary between base images in some embodiments.

It is also noted that in some embodiments there may be more than one entry corresponding a single footwear model in the initial database, rather than each entry corresponding to a different footwear model, with each entry being a different representation of the same footwear model. These entries may correspond to different shoe sizes, for instance, or different representations of the same footwear model. Each of these entries may be augmented separately, or they may be considered in combination such that the number of variations to be generated is determined on a per-footwear-model basis rather than a per-entry basis. Of course, any other method of handling multiple entries may also be considered appropriate.

A step 320 comprises generating an augmented dataset for use in the training of the machine learning model. This may include providing links between at least some of the generated variations and the corresponding entry from the initial dataset, or otherwise labelling each of the variations to indicate correspondence to a particular footwear model, but this is not considered to be essential. Examples of links include each variation having an identifier for the corresponding entry from the initial dataset, or the use of a data structure which links them such as a hierarchical data structure in which the variations are represented by child nodes of the entries in the original dataset.

In some embodiments more than one augmented dataset may be generated; one can be used as reference images for training the machine learning model while another can be used for confirming the reliability of the machine learning model, for example. In other words, augmented datasets may be generated for respective use as training datasets, validation datasets, and/or testing datasets. These datasets may be divided into separate groups of base images from the initial dataset, for instance, or may each comprise the same base images with differing (or only partially overlapping) selections of the augmented images generated in step 310.

FIG. 5 schematically illustrates a training method for a machine learning model which utilises an augmented dataset generated in accordance with the method of FIG. 3.

A step 500 comprises training a machine learning model to identify the presence of one or more features corresponding to descriptors such as those discussed with reference to FIG. 1 (or any alternative set of descriptors considered suitable for indicating features of footwear outsoles). While it is considered that any suitable training method may be used, embodiments of the present disclosure are described with reference to the use of a convolutional neural network (CNN). In other words, this machine learning model is trained to perform a feature recognition process, with the features being those corresponding to established descriptors.

This process can therefore be considered as a multi-label classification, with a label able to be defined for each of the descriptors used to classify outsole markings. These labels can be considered on a binary basis (as the feature can be identified as present or not present), which the labels not being mutually exclusive (in other words, an outsole can have features corresponding to more than one descriptor).

The input data set for this training includes a number of labelled images of outsoles; for instance, the data set used as an input in step 300 of FIG. 3 or the dataset generated in step 320 of FIG. 3. The use of the larger dataset may be advantageous in that it increases the number of samples that are available to the machine learning model, which can improve the quality of the training and of the eventual outputs of the machine learning model.

The training process may utilise a binary cross-entropy (or another suitable) loss function as a part of the identification process. The loss function quantifies the difference between the output of the machine learning model (i.e. the prediction) and the actual desired value, i.e. the ground truth. The entire machine learning model is trained using a stochastic gradient descent based algorithm to find a minimum of the loss function—the point where the loss (that is, the difference between the prediction and the ground truth) is minimised.

A step 510 comprises splitting the machine learning model trained in step 500 so as to extract the feature extractor portion of the machine learning model. This comprises fixing the early convolutional layers of the CNN, for example, whilst discarding the latter layers or enabling them to be modified further. This is referred to as transfer learning, as the feature extraction portion of the trained machine learning model can be repurposed for the identification of a database entry that corresponds to the input by adding a classifier. In other words, rather than outputting a determination of which features corresponding to descriptors are present it is considered advantageous to generate a machine learning model which identifies a specific database entry corresponding to an input.

A step 520 comprises adding dense layers on top of the feature extractor part of the machine learning model, along with an L2-normalised embeddings output layer. This updated machine learning model can then be trained, using a triplet loss function (for example), to identify footwear outsoles based upon an input image. An optimiser aims to determine the minimum of the loss function where distance between the embeddings of two footwear impressions from the same footwear model is lower than the distance between the embeddings of two different footwear models. Embeddings are a set of values which provide an abstract representation of the appearance of the respective footwear for which the embeddings are generated; when generated by a trained machine learning model, it is expected that footwear with similar appearances will also have similar embeddings.

The L2-normalisation on the embedding output layer is provided to force the embeddings into a unit hypersphere. This allows the embeddings to have a bounded Euclidean distance and the embedding distances to be comparable for the entire dataset. While the use of a triplet loss function is described here, alternative approaches to training may also be considered.

The triplet loss function may utilise labelled examples from the augmented database of step 320 of FIG. 3 as the positive, negative, and anchor examples. For instance, the anchor example could be an outsole image from a footwear database (that is, an un-augmented image) or an augmented version of such an image, with a positive example being an augmented version of the anchor image or another outsole image of the same footwear model, and the negative example being an augmented (or un-augmented) outsole image of different footwear model. The triplet loss function (or another loss function) can assist with the clustering of footwear examples (that is, cause similar footwear to have more similar embeddings than less-similar footwear).

The training process comprises the generation of embeddings so as to classify the positive example as being closer to the anchor example than the negative. These embeddings are n-dimensional floating point values which represent the abstract characteristics of the images, as learned via a stochastic gradient descent algorithm (or its derivative) to optimise the loss function. Any arbitrary number of dimensions may be considered suitable in practice; although it is generally considered advantageous that the selected number of dimensions is smaller than the dimensions of the input image to reduce computational complexity. In some cases, n is selected to be a power of two, such as one hundred and twenty-eight, two hundred and fifty-six, five hundred and twelve, and one thousand and twenty-four. In some embodiments, n may have the value of thirty-two; however, it should be noted that each of these values are entirely exemplary and should not be regarded as limiting as the value of n can be selected freely in dependence upon the machine learning model that is used. Those images which have embeddings which are closer to each other have more similar characteristics than those which have embeddings that are further apart; in other words, footwear that have similar embeddings are considered to have a more similar appearance.

The embeddings generation process can be performed using the original footwear model entry (or entries) along with at least a subset of the corresponding generated variations (in other words, while each of the generated variations may be used this is not required). The process then generates embeddings for each of these.

A step 530 comprises building a search index using the embeddings that are generated in step 520. This search index may be generated in any suitable manner; one example is that of a k-d (k-dimensional) tree. The search index comprises each of a number of reference outsole images; these may be only the reference images in the initial dataset as discussed above, or may include the augmented images in addition to these. These images may be arranged into a tree based upon their embeddings, with the tree being able to be traversed based upon information about the embedding value of a queried outsole image. This traversal is performed with the intention of identifying the nearest embedding value (or a plurality of values), with the identity of the outsoles corresponding to the identified value or values being considered the most likely matches for the outsole in the query image.

The search tree that is generated may be based upon the embeddings of any desired selection of embeddings. In some embodiments it may be considered advantageous to use embeddings corresponding to each of the footwear models in a database (that is, embeddings for each entry in the initial database and those generated for the variations on those footwear models). However, it is also considered that in some cases a more specialised tree may be designed—for instance, a separate search tree could be implemented for adult and child sizes of footwear respectively, or for particular brands or types of footwear where these are easy to identify (for instance, based upon the presence of an easily-identified logo). In this manner search trees may be generated in dependence upon any desired variable or characteristic by selecting an appropriate set of footwear and corresponding embeddings.

Of course, other alternatives to search trees may be implemented—this is merely an example of a data structure which can be used for an efficient search and identification of an outsole. The use of a search tree should therefore not be considered essential, as alternatives such as a hash-based search may also be effective.

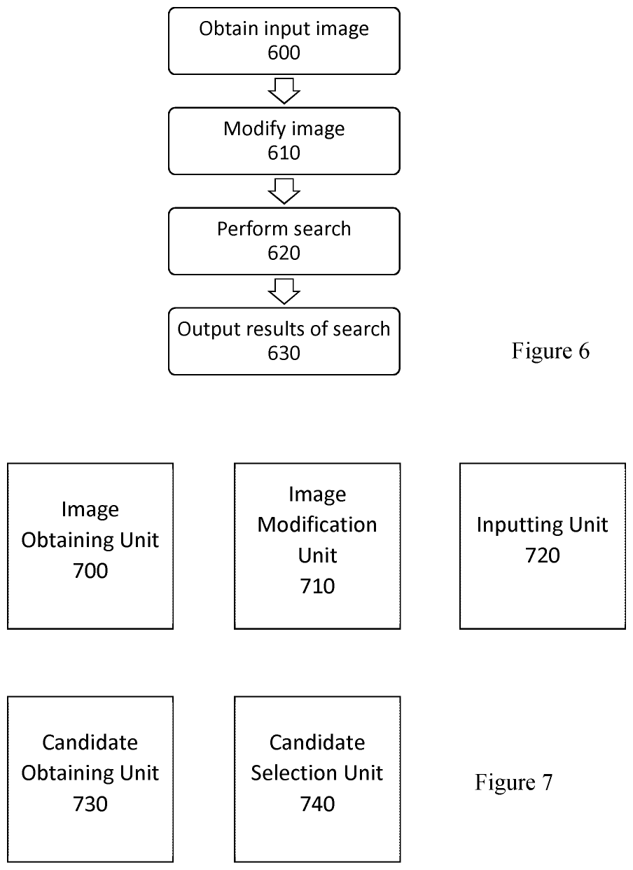

FIG. 6 schematically illustrates a method for utilising the trained machine learning model from FIG. 5; that is, the trained machine learning model referred to in step 520 in the discussion of FIG. 5. This method enables a query image to be input, with the output being one or more footwear identifications which correspond to the most likely identities of the footwear in the query image. Here, the identity of the footwear is considered to refer to a particular model of footwear; in other words, rather than trying to identify a specific shoe (such as a particular shoe owned by a particular person) the process would seek to identify the make and model of that shoe. This method does not require any classification of the query image to determine which descriptors are applicable as is performed in previous identification methods, and the search can be performed in an entirely automated manner.

A step 600 comprises obtaining an input (query) image; this image includes at least a portion of the outsole (or an impression of the outsole) of queried footwear. As discussed above, this query image may include an image or print of footwear that is obtained from the footwear of a person taken into custody, or the query image may be generated from a print or impression obtained from a crime scene in some embodiments.

An optional step 610 comprises performing one or more image modifications on the input image to render it suitable for use as an input to the trained machine learning model; in some cases, the input image is already suitable for use and as such this step may be omitted in those cases. This can include the performing of principal component analysis, for instance, as a part of a reorientation process for the image. Any other reorientation or resizing of the input image may also be considered, as well as modifications such as varying the contrast of the image or the like. The modifications may be performed in accordance with any criteria that are defined for the machine learning model, the criteria defined so as to describe properties of an input image that improve the chance of a successful search being performed.

A step 620 comprises performing the search using the image output by step 610 (if it is performed, otherwise the image obtained in step 600). In embodiments in which a search tree is used, this comprises generating embeddings for the query image using the trained machine learning model and then using the embeddings to traverse the search tree.

A step 630 comprises outputting the results of the search. The outputs include the identity of the one or more nearest neighbours identified by the search; in other words, the identity of the outsoles which are judged to be the most similar to that of the query image. The outputs may also indicate how near the embeddings are for the query image and each of the identified neighbours, or another measure of the degree of similarity or likelihood of the query and neighbour being a match (that is, both being outsole images representing the same footwear).

The output may be in the form of a sorted list of at least a subset of the footwear models represented by embeddings within the tree, the sorting being performed in dependence upon the distance between the embeddings generated for the query image and the respective embedding in the list. The distance between the embeddings is considered to be indicative of a similarity of the characteristics of the corresponding footwear images. These embeddings have a known correspondence with entries within the database (as they correspond directly to one of those entries, or a variation generated from a particular entry), and as such the embeddings can be used to identify a particular footwear model.

In some embodiments the output may instead be a single identity that is taken to be the identity of the outsole in the query image; in other embodiments the output may comprise a plurality of outputs that are provided to user in order to select a single identity. In some embodiments, the search may be configured to output a number of candidate identities in dependence upon the confidence level of each identification. This confidence level could be based upon whether a threshold distance between embeddings is exceeded, for example. For instance, if the embeddings are sufficiently close then there may be a high level of confidence in the identification and a single identity may be output while if there is a lower level of confidence then a number of candidates may be output instead.

FIG. 7 schematically illustrates a system for performing a footwear model identification process using a trained machine learning model. As discussed above, such a method may be particularly well-suited to the identification of a footwear model of an impression taken during custody, but could also be extended to the identification of impressions or prints obtained from a crime scene. A method for training the machine learning model is discussed with reference to FIG. 9 below, for example. The system comprises an image obtaining unit 700, an optional image modification unit 710, an inputting unit 720, a candidate obtaining unit 730, and a candidate selection unit 740. While shown here as separate units, the functionality of each of these may be implemented using These units may be implemented using one or more different hardware elements and/or devices. For instance, the machine learning model may be trained at a first device but then searches performed by a second device. The functions performed by the units shown may be implemented using any combination of central processing units (CPUs), tensor processing units (TPUs), graphics processing units (GPUs), or any appropriate computing device or devices as appropriate for providing an efficient and effective implementation.

The image obtaining unit 700 is operable to obtain a query image, the image comprising at least a portion of a footwear outsole. As noted above, this query image may be obtained in any manner including, but not limited to, inked impressions, two-or three-dimensional scans, photographs, and lifted prints. For instance, the query image may comprise an inked impression of an outsole, a photograph of an outsole, a lifted impression of an outsole, an image of a three-dimensional impression of an outsole, or a scan of an outsole.

The optional image modification unit 710 is operable to apply one or more modifications to the query image before it is used. The modifications may include one or more of reorientation, recolouring, contrast adjustment, cropping, and padding; these are selected and performed so as to cause the query image to be in a preferred format for an identification or to otherwise have desired characteristics (such as contrast, orientation, and size). For instance, the machine learning model may have been trained on images with a particular size and orientation and it may therefore be desirable to cause query images to have the same size and orientation by interpolating/cropping/padding and rotating the query images.

The inputting unit 720 is operable to input the query image to a trained machine learning model, the machine learning model being trained upon a data set comprising a footwear database and one or more augmented versions of entries in the footwear database. As discussed with reference to FIG. 3, the augmented versions of entries in the footwear database comprise images which have been cropped, distorted, and/or otherwise modified to obscure the features of the original entry in the footwear database. The trained machine learning model may further comprise a k-dimensional search tree of embeddings for images in the data set, which assists with the footwear identification process.

The candidate obtaining unit 730 is operable to obtain one or more candidate identifications of the footwear using the trained machine learning model, the candidates being entries in the footwear database. In some embodiments, the candidate obtaining unit is operable to obtain the n nearest neighbours of embeddings associated with the query image, where n is a positive integer. The obtaining of candidate identifications may include the generation of embeddings for the query image and the use of this to navigate a search tree.

The candidate selection unit 740 is operable to select one of the candidate identifications as the identity of the footwear outsole of the query image. The identity may be determined to be the candidate with the highest match probability (for instance, represented by the point with the shortest embeddings distance from the query image in the search tree), or a further process may be performed to select a candidate from amongst a plurality that are identified (such as a more direct image comparison).

The arrangement of FIG. 7 is an example of a processor (for example, a GPU, TPU, and/or CPU located in a general purpose computer, server, or any other computing device) that is operable to identify footwear outsoles, and in particular is operable to:
obtain a query image, the image comprising at least a portion of a footwear outsole;
input the query image to a trained machine learning model, the model being trained upon a data set comprising a footwear database and one or more augmented versions of entries in the footwear database;
obtain one or more candidate identifications of the footwear using the trained machine learning model, the candidates being entries in the footwear database; and
select one of the candidate identifications as the identity of the footwear outsole of the query image.

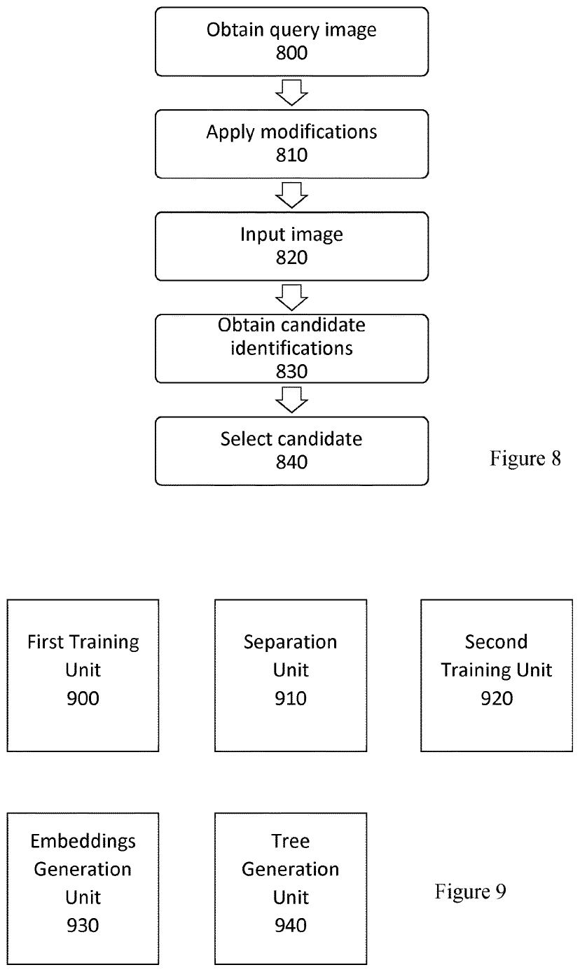

FIG. 8 schematically illustrates a method for identifying footwear outsoles from images or impressions of footwear outsoles.

A step 800 comprises obtaining a query image, the image comprising at least a portion of a footwear outsole.

An optional step 810 comprises applying one or more modifications to the query image before it is used.

A step 820 comprises inputting the query image (or the modified version, if step 810 is performed) to a trained machine learning model, the model being trained upon a data set comprising a footwear database and one or more augmented versions of entries in the footwear database;

A step 830 comprises obtaining one or more candidate identifications of the footwear using the trained machine learning model, the candidates being entries in the footwear database.

A step 840 comprises selecting one of the candidate identifications as the identity of the footwear outsole of the query image.

FIG. 9 schematically illustrates a system for training a machine learning model for the identification of footwear outsoles, the system comprising a first training unit 900, a separation unit 910, a second training unit 920, an embeddings generation unit 930, and a tree generation unit 940. Each of these functional units may be implemented by one or more processors (CPUs, TPUs, and/or GPUs) at a single device, or the functionality may be distributed amongst a number of devices as appropriate in a given implementation. The training process may be performed in accordance with the discussion of FIG. 5, for example.

The first training unit 900 is operable to train a descriptor classification model to identify the presence of one or more descriptors within a footwear outsole image. The descriptors may be representative of any type of features on the outsole, for instance those discussed with reference to FIG. 1 (or any alternative set of descriptors considered suitable for indicating features of footwear outsoles). The descriptor classification model may be a convolutional neural network in some embodiments, although other machine learning models may also be considered appropriate if they lead to an effective descriptor classification model.

The separation unit 910 is operable to separate the descriptor extractor portion of the descriptor classification model. In other words, the descriptor classification model may be divided into a descriptor extractor portion and a descriptor classifier portion which respectively extract and classify descriptors from an input. The classification portion of this may be discarded by the separation unit 910.

The second training unit 920 is operable to add a neural network on top of the descriptor extractor, and train this network to identify a footwear outsole to generate a trained identification model. In some embodiments, the neural network may be implemented using a number of dense layers as discussed in the examples above; however, any suitable neural network may be used for this purpose.

The second training unit 920 may also be operable to add an L2-normalised embeddings output layer, although other layers that assist in improving the fitting of the trained identification model (such as reducing the risk of overfitting) may be considered appropriate. The output of this second training unit 920 may be a trained identification model comprising the descriptor extractor portion of the descriptor classification model and the trained network and any other output layers that are added. In some embodiments the second training unit 920 may be configured to use a triplet loss function as a part of the training process, for instance for the training of the added neural network.

The embeddings generation unit 930 is operable to use the trained identification model (that is, the output of the second training unit 920) to generate embeddings for entries in a footwear reference database.

The tree generation unit 940 is operable to construct a search index, such as a k-dimensional search tree, using the generated embeddings. Any other type of search tree may also be considered, as well as alternative search implementations such as hashes.

The arrangement of FIG. 9 is an example of a processor (for example, a GPU and/or CPU located in a games console or any other computing device) that is operable to train a machine learning model for the identification of footwear outsoles, and in particular is operable to:
train a descriptor classification model to identify the presence of one or more descriptors within a footwear outsole image;
separate the descriptor extractor portion of the descriptor classification model;
add a neural network layers on top of the descriptor extractor, and train these layers to identify a footwear outsole to generate a trained identification model;
use the trained identification model to generate embeddings for entries in a footwear reference database; and
construct a search index, such as a k-dimensional search tree, using the generated embeddings.

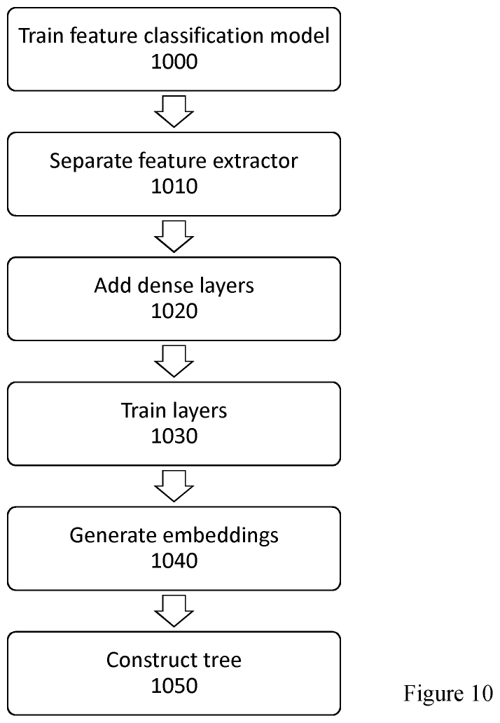

FIG. 10 schematically illustrates a method for training a machine learning model and generating a search tree for the identification of footwear outsoles.

A step 1000 comprises training a descriptor classification model to identify the presence of one or more descriptors within a footwear outsole image.

A step 1010 comprises separating the descriptor extractor portion of the descriptor classification model.

A step 1020 comprises adding a neural network on top of the descriptor extractor, as well as one or more layers to assist with the fitting process if desired (such as an L2-normalised embeddings output layer as discussed in examples above).

A step 1030 comprises training these layers to identify a footwear outsole to generate a trained identification model.

A step 1040 comprise using the trained identification model to generate embeddings for entries in a footwear reference database.

A step 1050 comprises constructing a search index, such as a k-dimensional search tree, using the generated embeddings.

The techniques described above may be implemented in hardware, software or combinations of the two. In the case that a software-controlled data processing apparatus is employed to implement one or more features of the embodiments, it will be appreciated that such software, and a storage or transmission medium such as a non-transitory machine-readable storage medium by which such software is provided, are also considered as embodiments of the disclosure.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A system for training a machine learning model for the identification of footwear outsoles, the system comprising:
a first training unit operable to train a descriptor classification model to identify presence of one or more descriptors within a footwear outsole image;
a separation unit operable to separate a descriptor extractor portion of the descriptor classification model;
a second training unit operable to add a neural network on top of the descriptor extractor portion, and train these layers to identify a footwear outsole to generate a trained identification model;
an embeddings generation unit operable to use the trained identification model to generate embeddings for entries in a footwear reference database; and
a tree generation unit operable to construct a search index using the generated embeddings.

2. The system of claim 1, wherein the descriptor classification model is a neural network.

3. The system of claim 1, wherein the second training unit is operable to add an L2-normalised embeddings output layer.

4. The system of claim 1, wherein the second training unit is operable to use a triplet loss function when performing the training.

5. A system for identifying footwear outsoles, the system comprising:
an image obtaining unit operable to obtain a query image, the image comprising at least a portion of a footwear outsole;
an inputting unit operable to input the query image to the trained machine learning model trained using the system of claim 1;
a candidate obtaining unit operable to obtain one or more candidate identifications of the footwear using the trained machine learning model, the candidates being entries in the footwear reference database; and
a candidate selection unit operable to select one of the candidate identifications as the identity of the footwear outsole of the query image.

6. The system of claim 5, further comprising an image modification unit operable to apply one or more modifications to the query image before it is used.

7. The system of claim 6, wherein the modifications include one or more of reorientation, recolouring, contrast adjustment, cropping, and padding.

8. The system of claim 5, wherein the query image comprises at least one of an inked impression of an outsole, a lifted impression of an outsole, an image of a three-dimensional impression of an outsole, or a scan of an outsole.

9. The system of claim 5, wherein the trained machine learning model is trained upon a data set comprising a footwear database and one or more augmented versions of entries in the footwear database, the augmented versions comprising images which have been cropped, distorted, and/or otherwise modified to obscure features of the original entry in the footwear database.

10. The system of claim 5, wherein the trained machine learning model comprises a k-dimensional search tree of embeddings for images in the data set.

11. The system of claim 10, wherein the candidate obtaining unit is operable to obtain n nearest neighbours of embeddings associated with the query image, where n is a positive integer.

12. A method for training a machine learning model and generating a search tree for identification of footwear outsoles, the method comprising:
training a descriptor classification model to identify a presence of one or more descriptors within a footwear outsole image;
separating a descriptor extractor portion of the descriptor classification model;
adding a neural network on top of the descriptor extractor portion;
training these layers to identify a footwear outsole to generate a trained identification model;
using the trained identification model to generate embeddings for entries in a footwear reference database; and
constructing a search index using the generated embeddings.

13. A method for identifying footwear outsoles, the method comprising:
obtaining a query image, the image comprising at least a portion of a footwear outsole;
inputting the query image to a machine learning model trained using a descriptor classification model to identify a presence of one or more descriptors within a footwear outsole image;
obtaining one or more candidate identifications of the footwear using the trained machine learning model, the candidates being entries in footwear reference database; and
selecting one of the candidate identifications as the identity of the footwear outsole of the query image.

14. (canceled)

15. (canceled)
